(19) United States
(12) Patent Application Publication
(10) Pub. No.: US 2016/0154764 A1
(43) Pub. Date: Jun. 2, 2016

(54) ELECTRONIC DEVICE AND ELECTRONIC DEVICE ASSEMBLY

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/587,398

(22) Filed: Dec. 31, 2014

(30) Foreign Application Priority Data
Nov. 28, 2014 (CN) 201410704267.9

(51) Int. Cl. G06F 13/42

(52) U.S. Cl. CPC G06F 13/4282

(57) ABSTRACT

An electronic device includes a system bus, an enhanced serial peripheral interface (e-SPI) bus, and a peripheral component interconnect express (PCI-E) socket. The PCI-E includes a plurality of functional pins and a plurality of reversed pins. The plurality of functional pins is coupled to the system bus. The plurality of reversed pins is coupled to the e-SPI bus.

### CROSS-REFERENCE TO RELATED APPLICATIONS

This application claims priority to Chinese Patent Application No. 201410704267.9 filed on Nov. 28, 2014, the contents of which are incorporated by reference herein.

### FIELD

The subject matter herein generally relates to an electronic device with debug port and an electronic device assembly with the electronic device.

### BACKGROUND

An electronic device needs to be tested for system compatibility or stability using a debug card before leaving a factory. A debug port is always defined in a motherboard of the electronic device to couple with a debug card.

### BRIEF DESCRIPTION OF THE DRAWINGS

Implementations of the present technology will now be described, by way of example only, with reference to the attached figures.

FIG. 1 is a diagrammatic view of an embodiment of an electronic device assembly.

FIG. 2 is a diagrammatic view of a PCI-E socket of the electronic device assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

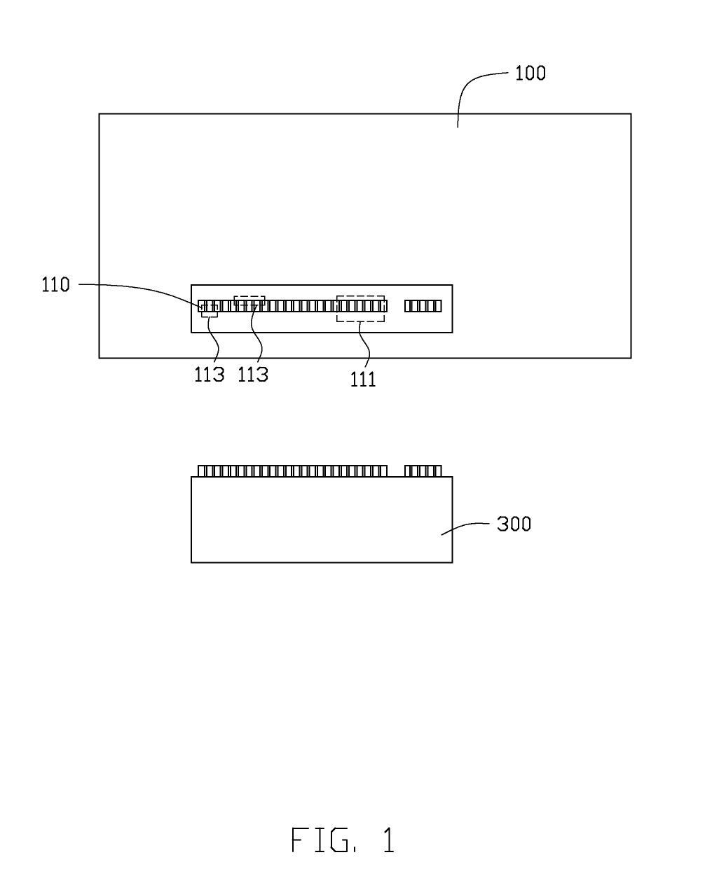

FIG. 1 illustrates a diagrammatic view of an electronic device assembly in one embodiment. The electronic device assembly includes an electronic device and a debug card 300. The electronic device can be a server, a laptop computer, a desktop computer, a tablet computer, an all-in-one computer, a smart TV, or a set-box-top.

The electronic device includes a motherboard 100. The motherboard 100 defines at least one system bus and an enhanced serial peripheral interface (e-SPI) bus. The at least on system bus can include a serial advanced technology attachment (SATA) bus, a PCI-E bus or an inter-integrated circuit (I2C) bus. An e-SPI bus is a successor to Low Pin Count (LPC) bus developed by Intel™. The e-SPI bus can be the reduction in the number of pins required on motherboards compared to systems using LPC. The e-SPI socket has more available throughput than the LPC socket. The working voltage of the e-SPI is 1.8 volts which is reduced to facilitate smaller chip manufacturing processes.

The motherboard 100 includes a peripheral component interconnect express (PCI-E) socket 110 working as a debug port. A PCI-E bus is a high-speed serial computer expansion bus standard designed to replace the older peripheral component interconnect (PCI), and accelerated graphics port (AGP) bus standards. The PCI-E slot can contain from one to thirty-two lanes. A lane is composed of two differential signaling pairs: one pair for receiving data, the other for transmitting. Each lane is composed of four wires or signal traces. Each lane is used as a full-duplex byte stream, transporting data packets in eight-bit format, between endpoints of a link, in both directions simultaneously.

The PCI-E socket 110 includes a plurality of functional pins 111 and a plurality of reversed pins 113. The plurality of functional pins 111 can be coupled to the system bus, such as PCI-E bus.

The debug card 300 can diagnose system problems of the electronic device when being coupled to the PCI-E socket 110.

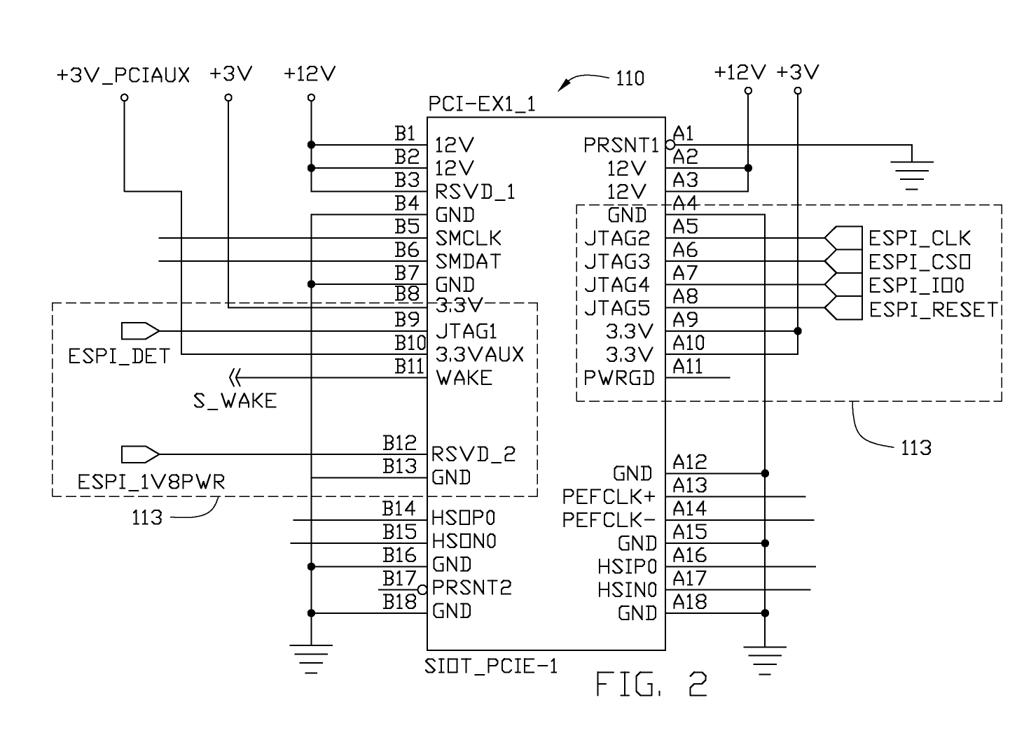

FIG. 2 is diagrammatic view of a PCI-E socket 110 of FIG. 1. The PCI-E socket 110 includes a number of pins A1-A18 and B1-B18. A plurality of pins B9, B12, A5, A6, A7, and A8 is defined as reversed pins 113. The plurality of reversed pins is coupled to the e-SPI bus. A number of the plurality of reversed pins 113 is six. At least pins B5, B6 may be defined as functional pins to couple with PCI-E bus. The PCI-E socket can include a plurality of pins aligned in two lines. The plurality of reversed pins 113 can be located on the two lines. The plurality of reversed pins 113 can be arranged discontinuously.

In other embodiments, a number of reversed pins can be defined to seven, or nine for greater data exchanging need.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An electronic device comprising:
a system bus and an enhanced serial peripheral interface (e-SPI) bus; and
a peripheral component interconnect express (PCI-E) socket comprising a plurality of functional pins and a plurality of reversed pins;
wherein the plurality of functional pins is coupled to the system bus; the plurality of reversed pins is coupled to the e-SPI bus.

2. The electronic device of claim 1, wherein the system bus comprises a peripheral component interconnect express (PCI-E) bus, and the plurality of functional pins is coupled to the PCI-E bus.

3. The electronic device of claim 1, wherein a number of the plurality of reversed pins is six.

4. The electronic device of claim 1, wherein a number of the plurality of reversed pins is nine.

5. The electronic device of claim 1, wherein the PCI-E comprises a plurality of pins aligned in two lines, and the plurality of reversed pins is located on the two lines.

6. The electronic device of claim 1, wherein the plurality of reversed pins is in arranged discontinuously.

7. An electronic device comprising:
an enhanced serial peripheral interface (e-SPI) bus; and
a peripheral component interconnect express (PCI-E) socket acted as a debug port, the PCI-E socket comprising a plurality of reversed pins;
wherein the plurality of reversed pins is coupled to the e-SPI bus.

8. The electronic device of claim 7, wherein a number of the plurality of reversed pins is six.

9. The electronic device of claim 7, wherein a number of the plurality of reversed pins is nine.

10. The electronic device of claim 7, wherein the PCI-E comprises a plurality of pins aligned in two lines, and the plurality of reversed pins is located on the two lines.

11. The electronic device of claim 7, wherein the plurality of reversed pins is arranged discontinuously.

12. An electronic device assembly comprising:
an electronic device comprising:
a system bus and an enhanced serial peripheral interface (e-SPI) bus; and
a peripheral component interconnect express (PCI-E) socket comprising a plurality of functional pins and a plurality of reversed pins; and
a debug card configured to coupled to the PCI-E socket for system debugging;
wherein the plurality of functional pins is coupled to the system bus; the plurality of reversed pins is coupled to the e-SPI bus.

13. The electronic device assembly of claim 12, wherein a number of the plurality of reversed pins is six.

14. The electronic device assembly of claim 12, wherein a number of the plurality of reversed pins is nine.

15. The electronic device assembly of claim 12, wherein the PCI-E comprises a plurality of pins aligned in two lines, and the plurality of reversed pins is located on the two lines.

16. The electronic device assembly of claim 12, wherein the plurality of reversed pins is arranged discontinuously.
